(19) United States
(12) Patent Application Publication
(10) Pub. No.: US 2023/0410240 A1
(43) Pub. Date: Dec. 21, 2023

(54) METHOD FOR REPRESENTING AND MEASURING DISASTER RESILIENCE OF URBAN PUBLIC SERVICES

(71) Applicants: Tongji University, Shanghai (CN); Anhui Jianzhu University, Hefei (CN)

(72) Inventors: Wentao YAN, Shanghai (CN); Zihao LI, Shanghai (CN); Zao LI, Hefei (CN); Lan WANG, Shanghai (CN); Shangwu ZHANG, Shanghai (CN); Kangkang GU, Hefei (CN); Shiping LIU, Shanghai (CN); Hui CHEN, Shanghai (CN)

(73) Assignees: Tongji University, Shanghai (CN); Anhui Jianzhu University, Hefei (CN)

(21) Appl. No.: 18/208,327

(22) Filed: Jun. 12, 2023

(30) Foreign Application Priority Data
Jun. 13, 2022 (CN) 202210661515.0

(51) Int. Cl. G06Q 50/26; G06Q 50/30

(52) U.S. Cl. CPC G06Q 50/265; G06Q 50/30

(57) ABSTRACT

A method for measuring disaster resilience of urban public services includes the following steps: constructing a residence-service-transportation space network under normal conditions; removing, through disaster simulation, failed road segments and function nodes to construct a damaged residence-service-transportation space network; calculating a per capita accessible public service of each residential node to represent network performance; calculating a change rate of the per capita accessible public service level before and after the disaster; and drawing a relation curve between the change rate and the disaster intensity to measure the disaster resilience of the urban public services.

### CROSS-REFERENCE TO THE RELATED APPLICATIONS

This application is based upon and claims priority to Chinese Patent Application No. 202210661515.0, filed on Jun. 13, 2022, the entire contents of which are incorporated herein by reference.

### TECHNICAL FIELD

The present disclosure relates to the technical field of urban disaster resilience analysis, and more particularly relates to a method for representing and measuring disaster resilience of urban public services.

### BACKGROUND

Various disasters and disturbances are important obstacles restricting urban safety and sustainable development, which seriously influence normal life of urban residents, and even will cause disastrous consequences such as loss of life and property and social order imbalance. Thus, urban resilience has become a new paradigm for urban risk government.

From the people-oriented perspective, a core demand of the urban resilience is to timely recognize change features of life of the urban residents and carrying space thereof in emergency when disasters occur, ensure efficient and stable operation of the city, and reduce influences of the disturbances on the accessible public service level of the residents to the minimum. Thus, measuring the disaster resilience level of the urban public services and analyzing a relationship between an urban space system and the disaster resilience level can provide a new technological tool for urban disaster management and resilient city construction.

Most of existing urban resilience measurement methods focus on survivability of single system performance, such as water supply, power transmission and communication, and represent the resilience level with service level changes of an urban system supply side in the disturbance process, or network structure feature changes, for example:
(1) “Method for Evaluating Urban Subway Waterlogging Disaster Resilience” (CN114169781A) evaluates the urban resilience from subway waterlogging;
(2) “Urban Resilience Evaluation Method for Emergency Management” (CN113191647A) evaluates the urban resilience from three different aspects including: pressure that the city copes with possible emergencies, the state of the city in emergency and emergency response made by the city after the emergencies;
(3) “System and Method for Evaluating Urban Flood Resilience Capacity” (CN113869807A) evaluates the urban resilience from urban blood;
(4) “Method for Evaluating Urban Ecological Resilience Based on Internet of Things and Big Data” (CN114021866A) evaluates the urban resilience from urban ecology;
(5) “Method for Evaluating Urban Rail Transit Network Resilience” (CN111882241A) evaluates the urban resilience from a rail transit network; and
(6) “Quantitative Measurement Method for Urban Street Network Resilience” (CN114037199A) evaluates the urban resilience from an urban street network structure.

But, due to a complex interrelated and synergistic mechanism among various elements of an urban complex system, there is a risk of cross-system transfer of functional failures caused by disasters, which will break an original supply-demand interaction system of the public services. Thus, the service level of the single system supply side or stability and resilience of a network structure cannot effectively guarantee that the urban residents can still normally obtain the public services in the situation of disasters. At present, there is a lack of a method for representing and measuring a disaster resilience level of urban public services, which describes, from the perspective of urban system interrelation and collaboration, a matching process from a supply side to a demand side of the urban services supported by multiple systems, and calculates the impact intensity of the disaster process on an overall operation state of the urban complex system and normal life of the residents.

### SUMMARY

Aiming to the above problems in the prior art, the present disclosure provides a method for representing and measuring disaster resilience of urban public services, which takes, from the perspective of urban system interrelation and synergism, an urban street network as a basic framework of an urban space form, fuses urban functions such as living, public services and traffic to construct an urban space complex network, describes a matching process from a supply side to a demand side of urban services supported by multiple systems, and calculates the impact intensity of the disaster process on an overall operation state of an urban complex system and normal life of residents.

The technical solution of the present disclosure is as below:

A method for representing and measuring disaster resilience of urban public services includes the following steps:
S1: collecting original space vector data of urban roads, and polygon data of public service facilities and residential communities; mapping an urban space into a weighted and directed urban basic space network based on the urban roads; and on that basis, mapping the public service facilities and the residential communities into function nodes in the network to construct a residence-service-transportation urban space complex network under normal conditions;
S2: taking the residence-service-transportation urban space complex network in step S1 as an initial scenario, removing, through experiment analog simulation, failed road segments that are impassable due to disturbances of different intensities of disasters, and constructing a damaged residence-service-transportation urban space complex network under different disaster intensities;
S3: allocating the service level of the public service facilities to residential nodes according to a flow cost and a supply-demand scale between residence-service point pairs, and calculating a per capita accessible public service level of residents within the residential nodes, thereby forming an urban space network performance model based on resident accessible public services;
S4: calculating a change rate of the per capita accessible public service level before and after a disaster in each statistical unit according to the urban space network performance model based on the resident accessible public services in step S3 to represent performance changes of the urban public services; and
S5: drawing a relation curve between the change rate of the per capita accessible public service level and the disaster intensity to measure the disaster resilience of the urban public services.

Further, a method for constructing the residence-service-transportation urban space complex network in step S1 includes the following steps:
S1-1: performing topology processing on the original space vector data of the urban roads, abstracting road intersections, ramps and the like as a point set Nₛ={n₁,n₂, . . . , nₖ}, abstracting road segments connecting the intersections and the ramps as an edge set Eₛ={l₁, l₂, . . . , lₘ}, and taking the Euclidean distance dₘ of an edge lₘ as a weight, thereby forming an urban basic space network diagram G(N_{S}, E_{S});
S1-2: extracting centroids of the polygon data of the residential communities, and taking population data as weights of the centroids to form a residential node set Nᵣ={r₁, r₂, . . . , rᵢ}; finding and connecting a road intersection point closest to each residential node to form a connection edge set Eᵣ={lᵣ₁, lᵣ₂, . . . , lᵣᵢ} connecting the residential nodes with the urban basic space network, taking the Euclidean distance dᵣᵢ of an edge lᵣᵢ as a weight, and abstractedly expressing a travel distance of the resident from the residential community to the urban road, thereby forming a residence-transportation complex urban space network diagram G(Nₛ ∪ Nᵣ, Eₛ ∪ Eᵣ); and
S1-3: extracting geographic position points of the public service facilities, and taking the service level of the facilities as weights of the points to constitute a public service node set N_{f}={f₁, f₂, . . . , fⱼ}; finding and connecting a road intersection point closest to each public service node to form a connection edge set E_{f}={l_{f1}, l_{f2}, . . . , l_{fj}} connecting the facilities with the urban basic space network; taking the Euclidean distance d_{fj} of an edge l_{fj} as a weight, and abstractedly expressing distances from the public service facilities to the urban roads, thereby forming the residence-service-transportation urban space complex network diagram G(N_{S} ∪ Nᵣ ∪ N₁, Eₛ ∪ Eᵣ ∪ E_{f}) under normal conditions.

Further, the operation of constructing a damaged residence-service-transportation urban space complex network under different disaster intensities in step S2 includes:
S2-1: recognizing urban road segments and urban lands influenced by the disasters with different disaster intensities through urban disaster experiment analog simulation; and
S2-2: overlapping a recognition result and the residence-service-transportation urban space complex network diagram under normal conditions, removing edges mapped by road segments failed due to the disasters from a complex network edge set Eₛ ∪ Eᵣ ∪ E_{f}, and removing road network nodes and public service nodes unaccessible for effective travel from a complex network point set Nₛ ∪ Nᵣ ∪ N_{f} to obtain the damaged residence-service-transportation urban space complex network under different disaster intensities.

Further, the operation of obtaining an urban space network performance model based on resident accessible public services in step S3 includes:
S3-1: calculating, based on a weight of an edge in the residence-service-transportation urban space complex network, a directed travel cost matrix A_{rf} between the residence-service point pairs according to a theoretical service range of the public services;
S3-2: allocating the service level of the public service facilities to the residential nodes according to the directed travel cost matrix A_{rf} between the residence-service point pairs and the scale of residence-service points, and calculating a service allocation ratio of a public service node j to a residential node i according to the following formula:

$${P}_{ij} = \frac{{M}_{j} {D}_{i} {/ [ {A}_{rf} ( i , j ) ]}^{α}}{{\sum }_{i = 0}^{n} {M}_{j} {D}_{i} {/ [ {A}_{rf} ( i , j ) ]}^{α}}$$

where Pᵢⱼ denotes the service allocation ratio of the public service node j to the residential node i, Mⱼ denotes the service level of the public service node j, Dᵢ denotes a demand scale of the residential community i, namely the resident population, n denotes the number of the residential nodes, α denotes a distance attenuation coefficient, and A_{rf}(i, j) denotes a value in an i^{th} row and a j^{th} column of the directed travel cost matrix A_{rf} between the residence-service point pairs; and
S3-3: calculating the per capita accessible public service level of the residents within the residential nodes in the residence-service-transportation urban space complex network according to the following formula:

$${A}_{i} = \frac{{Q}_{i}}{{D}_{i}} = \frac{{\sum }_{j = 1}^{k} {P}_{ij} {M}_{j}}{{D}_{i}}$$

where Aᵢ denotes the per capita accessible public service level of the residents at the residential node i, Qᵢ denotes the public service level acquired by the residential node i from all public service nodes, Pᵢⱼ denotes the service allocation ratio of the public service node j to the residential node i, Mⱼ denotes the service level of the public service node j, Dᵢ denotes the demand scale of the residential community i, namely the resident population, and k denotes the number of the public service nodes.

Further, a method for calculating, in different scenarios, a directed travel cost matrix A_{rf} between the residence-service point pairs according to a theoretical service range of the public services in step S3-1 includes:

$${A}_{rf} ( i , j ) = \{ \begin{matrix}{d}_{ij}^{min} , & if {d}_{ij}^{min} \leq {d}_{0} \\ ∞ , & if {d}_{ij}^{min} > {d}_{0} or {d}_{ij}^{min} = ∞\end{matrix}$$

where A_{rf}(i, j) denotes the value in the i^{th} row and the j^{th} column of the directed travel cost matrix A_{rf} between the residence-service point pairs A_{rf}, dᵢⱼ^{min} denotes a length of the shortest path from a residential node i to a public service facility j in the residence-service-transportation urban space complex network, and d₀ denotes the theoretical widest service range of the public services.

Further, the operation of calculating a change rate of the per capita accessible public service level before and after a disaster in each statistical unit to represent performance changes of the urban public services in step S4 includes:
S4-1: collecting a per capita accessible public service level Qₚᵣₑ under normal conditions and a per capita accessible public service level Qₚₒₛₜ after the disaster in each statistical unit, and calculating Qₚᵣₑ and Qₚₒₛₜ according to the following formulas:

$${Q}_{pre} = \frac{{\sum }_{i ∈ {N}_{r}} {A}_{i} {D}_{i}}{{\sum }_{i ∈ {N}_{r}} {D}_{i}}$$

$${Q}_{post} = \frac{{\sum }_{i ∈ {N}_{r}} {A}_{i}^{′} {D}_{i}}{{\sum }_{i ∈ {N}_{r}} {D}_{i}}$$

where i denotes the residential node, Nᵣ denotes the residential node set in the residence-service-transportation urban space complex network in the statistical unit, Aᵢ denotes the per capita accessible public service level of the residential node i under normal conditions, A′ᵢ denotes the per capita accessible public service level of the residential node i after the disaster, and Dᵢ denotes the demand scale of the residential community i, namely the resident population.

S4-2: calculating the change rate P of the urban per capita accessible public service level under different disaster intensities, and calculating P according to the following formula:

$$P = \frac{{Q}_{post}^{a}}{{Q}_{pre}}$$

where Qₚᵣₑ denotes the per capita accessible public service level under normal conditions, and Qₚₒₛₜ^{a} denotes the per capita accessible public service level after the disaster with the intensity of a.

Further, the operation of drawing a relation curve between the change rate of the per capita accessible public service level and the disaster intensity to measure the disaster resilience of the urban public services in step S5 includes:
S5-1: drawing a change relation curve between the change rate P of the urban per capita accessible public service level and the disaster intensity, where an x-coordinate denotes the disaster intensity, and a y-coordinate denotes the performance change degree of the public services;
S5-2: solving network connected subgraphs of the residence-service-transportation urban space complex network under different disaster intensities, which are arranged in descending order of the number of nodes, and extracting the size of a second largest connected subgraph;
S5-3: recognizing a maximum value of the second largest connected subgraph of the residence-service-transportation urban space complex network under disaster intensity changes, which is regarded as a critical state that a network structure reaches fragmentation, and serves as a threshold point of the bearable disaster intensity of the network structure; and
S5-4: calculating, before the threshold point at which the residence-service-transportation urban space complex network structure crashes, an integral value of the change rate P of the public service level to the disaster intensity to represent the disaster resilience of the urban public services according to the following formula:

R=∫₀^{a}^{ₘₐₓ}(Qₚₒₛₜ|Qₚᵣₑ)da

where Qₚᵣₑ denotes the per capita accessible public service level under normal conditions, Qₚₒₛₜ denotes the per capita accessible public service level after the disaster, and aₘₐₓ denotes the threshold point at which the residence-service-transportation urban space complex network structure crashes.

The present disclosure has the following advantages:
(1) the present disclosure takes the maintenance of the resident accessible public service level as a core objective of the urban resilience, and fuses a complex network theory and an urban public service supply-demand allocation model to generalize a flow process of the residents obtaining the public services and a travel cost as a connection path and a weight in the complex network; and a basic conceptual model for resilience level measurement is provided, which abstractedly expresses a multi-system interrelated and synergistic relationship and analyzes an interaction mechanism among disaster disturbances, space structure and the accessible service level on the resident demand side;
(2) compared with a current common method for measuring a resilience level, which represents single system performance with a surrogate-based index, the present disclosure regards the city as a complex system, and draws the matching process from the supply side to the demand side of the urban services in experiments, represents dynamic evolution of overall performance of an urban combined system with the change degree of the resident accessible public services, and constructs a method and a calculation model for measuring the disaster resilience of the urban public services to clearly represent the urban resilience level; and
(3) the present disclosure may disclose the changes of performance of the urban residence-service-transportation complex system in the disturbance process, analyze difference of the resilience level in different areas and different time periods, recognizes the bearable disaster intensity and key structure elements, and provides a technological tool for improving the resilience level of an urban system in planning practice.

### BRIEF DESCRIPTION OF THE DRAWINGS

FIG. 1 is a flowchart of the present disclosure; and

FIG. 2 illustrates relation curves between change rates of urban public service levels and disaster intensities according to an embodiment.

### DETAILED DESCRIPTION OF THE EMBODIMENTS

The present disclosure is specifically described in combination with drawings and embodiments below. It is apparent that the described embodiments are merely a part rather all embodiments of the present disclosure. Based on the embodiments of the present disclosure, all other embodiments obtained by those of ordinary skill in the art without contributing creative labor shall fall within the scope of protection of the present disclosure.

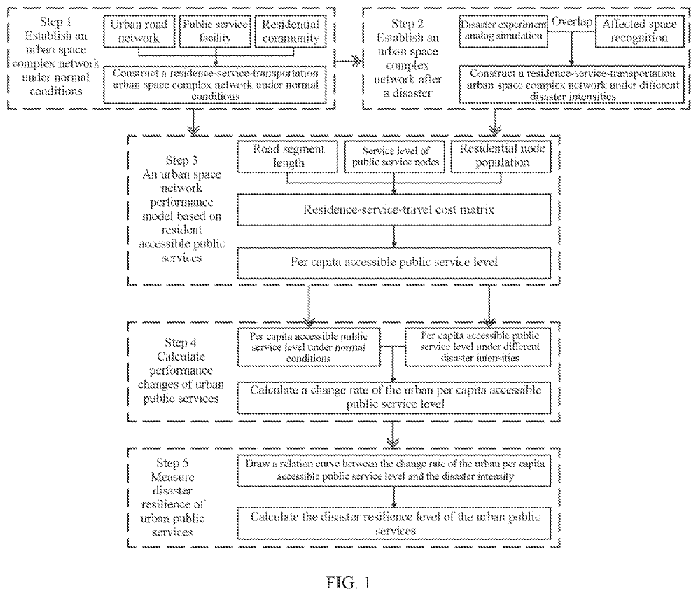

A flowchart of the present disclosure is shown as FIG. 1. The present disclosure is adopted to measure disaster resilience of comprehensive medical service facilities in Central Shanghai during rainstorm waterlogging, and specific steps are as below:
S1: An urban space is mapped into a weighted and directed urban basic space network based on urban roads; and on that basis, public service facilities and residential communities are mapped into function nodes in the network to construct a residence-service-transportation urban space complex network under normal conditions. Specific steps are as below:
S1-1: Original space vector data of all earth-surface urban road networks in a branch level or above in an open source map, including an expressway interchange system, is acquired by utilizing OSMnx and NetworkX model libraries in Python; China Geodetic Coordinate System 2000 (CGCS2000) projection is adopted to perform ArcGIS visual representation; and basic information, such as road names, traffic directions, road segment lengths, whether it is an overpass or not, and whether it is a tunnel or not is recorded in attribute tables of corresponding road segments.

S1-2: An open source map API is invoked to collect polygon data of the public service facilities and the residential communities, and the China Geodetic Coordinate System 2000 (CGCS2000) projection is similarly adopted to perform the ArcGIS visual representation; centroids of the polygon data of the public service facilities and the residential communities are extracted to represent their relative position relationships in the city; and based on statistical data of the public service facilities and population census data, the service level of the public service facilities and the population of the residential communities are recorded in attribute tables of the corresponding centroids.

S1-3: The road networks, the public service facilities, spatial positions of the residential communities and the attribute tables are converted, by utilizing a Geopandas model library in the Python, into a computational DataFrame data structure.

S1-4: Topology processing is performed on the urban road networks, road intersections, ramps and the like are extracted as a point set Nₛ ={n₁, n₂, . . . , nₖ}, road segments connecting the intersections and the ramps are extracted as an edge set Eₛ ={l₁, l₂, . . . , lₘ}, and the Euclidean distance dₘ of an edge lₘ is taken as a weight, thereby forming an urban basic space network diagram G(N_{S}, E).

S1-5: Topology processing is performed on mass points corresponding to the residential communities, and the population of the residential communities is taken as a weight to form a residential node set Nᵣ={r₁, r₂, . . . , rᵢ}. A road intersection point closest to each residential node is found and connected to form a connection edge set Eᵣ={lᵣ₁, lᵣ₂, . . . , lᵣᵢ}connecting the residential nodes with the urban basic space network, the Euclidean distance dᵣᵢ of an edge lᵣᵢ is taken as a weight, and a travel distance of the resident from the residential community to the urban road is abstractedly expressed, thereby forming a residence-transportation complex urban space network diagram G(Nₛ ∪ Nᵣ, Eₛ ∪ Eᵣ).

S1-6: Topology processing is performed on mass points corresponding to the public service facilities, and the service levels of the facilities are taken as weights of the points, thereby forming a public service node set N_{f}={f₁, f₂, . . . , fⱼ}. A road intersection point closest to each public service node is found and connected to form a connection edge set E_{f}={l_{f1}, l_{f2}, . . . , l_{fj}} connecting the facilities with the urban basic space network. The Euclidean distance d_{fj} of an edge l_{fj} is taken as a weight, and distances from the public service facilities to the urban roads are abstractedly expressed, thereby forming the residence-service-transportation urban space complex network diagram G(N_{S} ∪ Nᵣ ∪ N_{f}, Eₛ ∪ Eᵣ ∪ E_{f}) under normal conditions.

S2: The residence-service-transportation urban space complex network in step S1 is taken as an initial scenario, failed road segments that are impassable due to disturbances of different intensities of disasters are removed through experiment analog simulation, and a damaged residence-service-transportation urban space complex network under different disaster intensities is constructed. Specific steps are as below:
S2-1: Urban road segments and urban lands influenced by the disasters with different disaster intensities are recognized through urban disaster experiment analog simulation.
S2-2: A recognition result and the residence-service-transportation urban space complex network diagram under normal conditions are overlapped to determine, in the disaster scenario, failed nodes and edges in the residence-service-transportation urban space complex network under normal conditions; the residence-service-transportation urban space complex network under normal conditions is processed by a Remove function in the Python, edges mapped by road segments failed due to the disasters are removed from a complex network edge set Eₛ ∪ Eᵣ ∪ E_{f}, and road network nodes and public service nodes unaccessible for effective travel are removed from a complex network point set Nₛ ∪ Nᵣ ∪ N_{f}, and thus, the damaged residence-service-transportation urban space complex network under different disaster intensities is obtained.

S3: The service level of the public service facilities is allocated to the residential nodes according to a flow cost and a supply-demand scale between residence-service point pairs, and a per capita accessible public service level of residents within the residential nodes is calculated, thereby forming an urban space network performance model based on resident accessible public services. Specific steps are as below:
S3-1: By a Dijkstra shortest path algorithm provided in a NetworkX model package, a length of the shortest path between the residence-service point pairs in different scenarios is calculated according to weights of edges in the residence-service-transportation urban space complex network, and if there is no passage therebetween, it is recorded as ∞.
S3-2: A directed travel cost matrix A_{rf} between the residence-service point pairs under different scenarios is formed according to a theoretical service range of the public services, and a computing method of the directed travel cost matrix Art is:

$${A}_{rf} ( i , j ) = \{ \begin{matrix}{d}_{ij}^{min} , & if {d}_{ij}^{min} \leq {d}_{0} \\ ∞ , & if {d}_{ij}^{min} > {d}_{0} or {d}_{ij}^{min} = ∞\end{matrix}$$

A_{rf}(i, j) denotes the value in an i^{th} row and a j^{th} column of the directed travel cost matrix A_{rf} between the residence-service point pairs A_{rf}, dᵢⱼ^{min} denotes a length of the shortest path from a residential node i to a public service facility j in the residence-service-transportation urban space complex network, and dₒ denotes the theoretical widest service range of the public services.

S3-3: The service level of the public service facilities is allocated to the residential nodes according to the directed travel cost matrix A_{rf} between residence-service point pairs and the scale of the residence-service points. A service allocation ratio of a public service node j to the residential node i is calculated according to the following formula:

$${P}_{ij} = \frac{{M}_{j} {D}_{i} {/ [ {A}_{rf} ( i , j ) ]}^{α}}{{\sum }_{i = 0}^{n} {M}_{j} {D}_{i} {/ [ {A}_{rf} ( i , j ) ]}^{α}}$$

In the formula, Pᵢⱼ denotes the service allocation ratio of the public service node j to the residential node i, Mⱼ denotes the service level of the public service node j, Dᵢ denotes a demand scale of the residential community i, namely the resident population, n denotes the number of the residential nodes, a denotes a distance attenuation coefficient, and A_{rf}(i, j) denotes a value in the i^{th} row and the j^{th} column of the directed travel cost matrix A_{rf} between the residence-service point pairs Arr.

S3-4: The per capita accessible public service level of the residents within the residential nodes in the residence-service-transportation urban space complex network is calculated according to the following formula:

$${A}_{i} = \frac{{Q}_{i}}{{D}_{i}} = \frac{{\sum }_{j = 1}^{k} {P}_{ij} {M}_{j}}{{D}_{i}}$$

In the formula, Aᵢ denotes the per capita accessible public service level of the residents at the residential node i, Qᵢ denotes the public service level acquired by the residential node i from all public service nodes, Pᵢⱼ denotes the service allocation ratio of the public service node j to the residential node i, Mⱼ denotes the service level of the public service node j, Dᵢ denotes the demand scale of the residential community i, namely the resident population, and k denotes the number of the public service nodes.

S4: A change rate of the per capita accessible public service level before and after a disaster in each statistical unit is calculated according to the urban space network performance model based on the resident accessible public services in step S3 to represent performance changes of the urban public services. Specific steps are as below:
S4-1: A per capita accessible public service level Qₚᵣₑ under normal conditions and a per capita accessible public service level Qₚₒₛₜ after the disaster in each statistical unit is collected, and Qₚᵣₑ and Qₚₒₛₜ are calculated according to the following formulas:

$${Q}_{pre} = \frac{{\sum }_{i ∈ {N}_{r}} {A}_{i} {D}_{i}}{{\sum }_{i ∈ {N}_{r}} {D}_{i}}$$

$${Q}_{post} = \frac{{\sum }_{i ∈ {N}_{r}} {A}_{i}^{′} {D}_{i}}{{\sum }_{i ∈ {N}_{r}} {D}_{i}}$$

i denotes the residential node, Nᵣ denotes the residential node set in the residence-service-transportation urban space complex network in the statistical unit, Aᵢ denotes the per capita accessible public service level of the residential node i under normal conditions, A′ᵢ denotes the per capita accessible public service level of the residential node i after the disaster, and Dᵢ denotes the demand scale of the residential community i, namely the resident population.

S4-2: The change rate P of the urban per capita accessible public service level under different disaster intensities is calculated, and P is calculated according to the following formula:

$$P = \frac{{Q}_{post}^{a}}{{Q}_{pre}}$$

In the formula, Qₚᵣₑ denotes the per capita accessible public service level under normal conditions, and Qₚₒₛₜ denotes the per capita accessible public service level after the disaster with the intensity of a.

S5: A relation curve between the change rate of the per capita accessible public service level and the disaster intensity is drawn to measure the disaster resilience of the urban public services. Specific steps are as below:
S5-1: The change relation curve between the change rate P of the urban per capita accessible public service level and the disaster intensity is drawn by a Matplotlib module, an x-coordinate denotes the disaster intensity, and a y-coordinate denotes the performance change degree of the public services.
S5-2: Network connected subgraphs of the residence-service-transportation urban space complex network under different disaster intensities are solved by invoking a connected_components function in the NetworkX model library and arranged in descending order of the number of nodes, and the size of a second largest connected subgraph is extracted.
S5-3: The Matplotlib module is applied to recognize a maximum value of the second largest connected subgraph of the residence-service-transportation urban space complex network under disaster intensity changes, which is regarded as a critical state that a network structure reaches fragmentation, and serves as a threshold point of the bearable disaster intensity of the network structure.
S5-4: Before the threshold point at which the residence-service-transportation urban space complex network structure crashes, an integral value of the change rate P of the public service level to the disaster intensity is calculated to represent the disaster resilience of the urban public services according to the following formula:

R=∫₀^{a}^{ₘₐₓ}(Qₚₒₛₜ/Qₚᵣₑ)da

Qₚᵣₑ denotes the per capita accessible public service level under normal conditions, Qₚₒₛₜ denotes the per capita accessible public service level after the disaster, and aₘₐₓ denotes the threshold point at which the residence-service-transportation urban space complex network structure crashes.

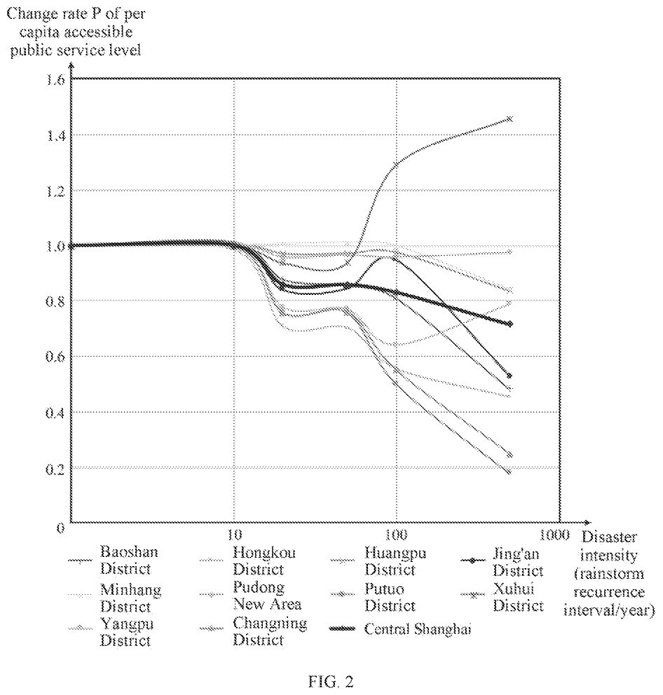

FIG. 2 illustrates, in a rainstorm waterlogging scenario, relation curves between the change rate P of the per capita accessible comprehensive medical care service level and the disaster intensity in the Central Shanghai and its 10 municipal districts, where the comprehensive medical care service level is denoted by the number of hospital beds, and the disaster intensity is denoted by a rainstorm waterlogging recurrence interval. An enclosed area of the curve, an x-coordinate and a y-coordinate is calculated, thereby measuring the disaster resilience level of urban comprehensive medical care services of the different areas.

Although the implementation scheme of the present disclosure has been disclosed above, it is not merely limited to applications listed in the specification and the implementations, and can be completely applicable to various fields suitable for the present disclosure. Those personnel familiar with the art and those of ordinary skill in the art may perform multiple changes, modifications, substitutions and variations on these embodiments without departing from the principle and spirit of the present disclosure, and thus, the present disclosure is not limited to specific details without departing from a general concept limited by the claims and the equivalent scope.

What is claimed is:

1. A method for representing and measuring a disaster resilience of urban public services, comprising the following steps:
S1: collecting original space vector data of urban roads, and polygon data of public service facilities and residential communities; mapping an urban space into a weighted and directed urban basic space network based on the urban roads; and on that basis, mapping the public service facilities and the residential communities into function nodes in the weighted and directed urban basic space network to construct a residence-service-transportation urban space complex network under normal conditions;
S2: taking the residence-service-transportation urban space complex network in step S1 as an initial scenario, removing, through an experiment analog simulation, failed road segments, wherein the failed road segments are impassable due to disturbances of different intensities of disasters, and constructing a damaged residence-service-transportation urban space complex network under different disaster intensities;
S3: allocating a service level of the public service facilities to residential nodes according to a flow cost and a supply-demand scale between residence-service point pairs, and calculating a per capita accessible public service level of residents within the residential nodes, thereby forming an urban space network performance model based on resident accessible public services;
S4: calculating a change rate of the per capita accessible public service level before and after a disaster in each statistical unit according to the urban space network performance model based on the resident accessible public services in step S3 to represent performance changes of the urban public services; and
S5: drawing a relation curve between the change rate of the per capita accessible public service level and the disaster intensity to measure the disaster resilience of the urban public services.

2. The method for representing and measuring the disaster resilience of the urban public services according to claim 1, wherein a method for constructing the residence-service-transportation urban space complex network in step S1 comprises the following steps:
S1-1: performing a topology processing on the original space vector data of the urban roads, abstracting road intersections, and ramps as a point set Nₛ={n₁, n₂, . . . , nₖ}, abstracting road segments connecting the road intersections and the ramps as an edge set Eₛ ={l₁, l₂, . . . , lₘ}, and taking an Euclidean distance dₘ of an edge lₘ as a weight, thereby forming an urban basic space network diagram G(N_{S}, Eₛ);
S1-2: extracting centroids of the polygon data of the residential communities, and taking population data as weights of the centroids to form a residential node set Nᵣ={r₁, r₂, . . . , rᵢ}; finding and connecting a road intersection point closest to each of the residential nodes to form a connection edge set Eᵣ={lᵣ₁, lᵣ₂, . . . , lᵣᵢ} connecting the residential nodes with the weighted and directed urban basic space network, taking an Euclidean distance dᵣᵢ of an edge lᵣᵢ as a weight, and abstractedly expressing a travel distance of the resident from the residential community to the urban road, thereby forming a residence-transportation complex urban space network diagram G(N_{S} ∪ Nᵣ, Eₛ ∪ Eᵣ); and
S1-3: extracting geographic position points of the public service facilities, and taking the service level of the public service facilities as weights of the points to constitute a public service node set N_{f}={f₁, f₂, . . . , fⱼ}; finding and connecting a road intersection point closest to each public service node to form a connection edge set E_{f}={l_{f1}, l_{f2}, . . . , l_{fj}} connecting the public service facilities with the weighted and directed urban basic space network; taking an Euclidean distance d_{fj} of an edge l_{fj} as a weight, and abstractedly expressing distances from the public service facilities to the urban roads, thereby forming a residence-service-transportation urban space complex network diagram G(N_{S} ∪ Nᵣ ∪ N_{f}, Eₛ ∪ Eᵣ ∪ Eᵣ) under normal conditions.

3. The method for representing and measuring the disaster resilience of the urban public services according to claim 1, wherein the operation of constructing the damaged residence-service-transportation urban space complex network under the different disaster intensities in step S2 comprises:
S2-1: recognizing urban road segments and urban lands influenced by the disasters with different disaster intensities through an urban disaster experiment analog simulation to obtain a recognition result; and
S2-2: overlapping the recognition result and a residence-service-transportation urban space complex network diagram under normal conditions, removing edges mapped by road segments failed due to the disasters from a complex network edge set Eₛ ∪ Eᵣ ∪ E_{f}, and removing road network nodes and public service nodes unaccessible for an effective travel from a complex network point set Nₛ ∪ Nᵣ ∪ N_{f} to obtain the damaged residence-service-transportation urban space complex network under the different disaster intensities.

4. The method for representing and measuring the disaster resilience of the urban public services according to claim 1, wherein the operation of obtaining the urban space network performance model based on the resident accessible public services in step S3 comprises:
S3-1: calculating, based on a weight of an edge in the residence-service-transportation urban space complex network, a directed travel cost matrix A_{rf} between the residence-service point pairs according to a theoretical service range of the public services;
S3-2: allocating the service level of the public service facilities to the residential nodes according to the directed travel cost matrix A_{rf} between the residence-service point pairs and a scale of residence-service points, and calculating a service allocation ratio of a public service node j to a residential node i according to the following formula:
$${P}_{ij} = \frac{{M}_{j} {D}_{i} {/ [ {A}_{rf} ( i , j ) ]}^{α}}{{\sum }_{i = 0}^{n} {M}_{j} {D}_{i} {/ [ {A}_{rf} ( i , j ) ]}^{α}}$$
wherein Pᵢⱼ denotes the service allocation ratio of the public service node j to the residential node i, Mⱼ denotes the service level of the public service node j, Dᵢ denotes a demand scale of a residential community i, namely a resident population, n denotes a number of the residential nodes, a denotes a distance attenuation coefficient, and A_{rf}(i, j) denotes a value in an i^{th} row and a j^{h} column of the directed travel cost matrix A_{rf} between the residence-service point pairs; and
S3-3: calculating the per capita accessible public service level of the residents within the residential nodes in the residence-service-transportation urban space complex network according to the following formula:
$${A}_{i} = \frac{{Q}_{i}}{{D}_{i}} = \frac{{\sum }_{j = 1}^{k} {P}_{ij} {M}_{j}}{{D}_{i}}$$
wherein Ai denotes the per capita accessible public service level of the residents at the residential node i, Qᵢ denotes a public service level acquired by the residential node i from all public service nodes, Pᵢⱼ denotes the service allocation ratio of the public service node j to the residential node i, Mⱼ denotes the service level of the public service node j, Dᵢ denotes the demand scale of the residential community i, namely the resident population, and k denotes a number of the public service nodes.

5. The method for representing and measuring the disaster resilience of the urban public services according to claim 4, wherein a method for calculating, in different scenarios, a directed travel cost matrix A_{rf} between the residence-service point pairs according to the theoretical service range of the public services in step S3-1 comprises:
$${A}_{rf} ( i , j ) = \{ \begin{matrix}{d}_{ij}^{min} , & if {d}_{ij}^{min} \leq {d}_{0} \\ ∞ , & if {d}_{ij}^{min} > {d}_{0} or {d}_{ij}^{min} = ∞\end{matrix}$$
wherein A_{rf}(i, j) denotes the value in the i^{h} row and the j*^{h} column of the directed travel cost matrix A_{rf} between the residence-service point pairs A_{rf}, dᵢⱼ^{min} denotes a length of a shortest path from a residential node i to a public service facility j in the residence-service-transportation urban space complex network, and d₀ denotes a theoretical widest service range of the public services.

6. The method for representing and measuring the disaster resilience of the urban public services according to claim 1, wherein the operation of calculating the change rate of the per capita accessible public service level before and after the disaster in each statistical unit to represent the performance changes of the urban public services in step S4 comprises:
S4-1: collecting a per capita accessible public service level Qₚᵣₑ under normal conditions and a per capita accessible public service level Qₚₒₛₜ after the disaster in each statistical unit, and calculating Qₚᵣₑ and Qₚₒₛₜ according to the following formulas:
$${Q}_{pre} = \frac{{\sum }_{i ∈ {N}_{r}} {A}_{i} {D}_{i}}{{\sum }_{i ∈ {N}_{r}} {D}_{i}}$$
$${Q}_{post} = \frac{{\sum }_{i ∈ {N}_{r}} {A}_{i}^{′} {D}_{i}}{{\sum }_{i ∈ {N}_{r}} {D}_{i}}$$
wherein i denotes the residential node, Nᵣ denotes a residential node set in the residence-service-transportation urban space complex network in the statistical unit, Ai denotes a per capita accessible public service level of a residential node i under the normal conditions, A′ᵢ denotes a per capita accessible public service level of the residential node i after the disaster, and Dᵢ denotes a demand scale of a residential community i, namely a resident population; and
S4-2: calculating the change rate P of the urban per capita accessible public service level under the different disaster intensities, and calculating P according to the following formula:
$$P = \frac{{Q}_{post}^{a}}{{Q}_{pre}}$$
wherein Qₚᵣₑ denotes the per capita accessible public service level under the normal conditions, and Qₚₒₛₜ denotes a per capita accessible public service level after a disaster with an intensity of a.

7. The method for representing and measuring the disaster resilience of the urban public services according to claim 1, wherein the operation of drawing the relation curve between the change rate of the per capita accessible public service level and the disaster intensity to measure the disaster resilience of the urban public services in step S5 comprises:
S5-1: drawing a change relation curve between the change rate P of the urban per capita accessible public service level and the disaster intensity, wherein an x-coordinate denotes the disaster intensity, and a y-coordinate denotes a performance change degree of the public services;
S5-2: solving network connected subgraphs of the residence-service-transportation urban space complex network under the different disaster intensities, wherein the network connected subgraphs are arranged in a descending order of a number of nodes, and extracting a size of a second largest connected subgraph;
S5-3: recognizing a maximum value of the second largest connected subgraph of the residence-service-transportation urban space complex network under disaster intensity changes, wherein the maximum value is regarded as a critical state that a network structure reaches a fragmentation, and serves as a threshold point of a bearable disaster intensity of the network structure; and
S5-4: calculating, before the threshold point where a residence-service-transportation urban space complex network structure crashes, an integral value of the change rate P of the public service level to the disaster intensity to represent the disaster resilience of the urban public services according to the following formula:
R=∫₀^{a}^{ₘₐₓ}(Qₚₒₛₜ/Qₚᵣₑ)da
wherein Qₚᵣₑ denotes a per capita accessible public service level under the normal conditions, Qₚₒₛₜ denotes a per capita accessible public service level after the disaster, and aₘₐₓ denotes the threshold point where the residence-service-transportation urban space complex network structure crashes.
